(19) United States
(12) Patent Application Publication
(10) Pub. No.: US 2024/0273218 A1
(43) Pub. Date: Aug. 15, 2024

(54) APPARATUS AND METHOD WITH NEURAL NETWORK OPERATION OF HOMOMORPHIC ENCRYPTED DATA

(71) Applicants: Samsung Electronics Co., Ltd., Suwon-si (KR); Seoul National University R&DB Foundation, Seoul (KR); Daegu Gyeongbuk Institute of Science and Technology, Daegu (KR); Industry Academic Cooperation Foundation, Chosun University, Gwangju (KR)

(72) Inventors: Jong Seon NO, Seoul (KR); Eun Sang LEE, Seoul (KR); Joon Woo LEE, Seoul (KR); Young Sik KIM, Gwangju (KR); Yongjune KIM, Daegu (KR); Jung Hyun LEE, Seoul (KR)

(73) Assignees: Samsung Electronics Co., Ltd., Suwon-si (KR); Seoul National University R&DB Foundation, Seoul (KR); Daegu Gyeongbuk Institute of Science and Technology, Daegu (KR); Industry Academic Cooperation Foundation, Chosun University, Gwangju (KR)

(21) Appl. No.: 18/498,667

(22) Filed: Oct. 31, 2023

(30) Foreign Application Priority Data
Feb. 10, 2023 (KR) 10-2023-0017831

(51) Int. Cl. G06F 21/60; G06F 7/487; G06F 17/15

(52) U.S. Cl. CPC G06F 21/602; G06F 7/4876; G06F 17/156

(57) ABSTRACT

An apparatus with a neural network operation of homomorphic encrypted data includes: one or more processors configured to: generate homomorphic conjugation data of encrypted data based on the encrypted data, wherein the encrypted data corresponds to an output of each of a plurality of layers included in a neural network; and remove noise of the encrypted data based on the encrypted data and the homomorphic conjugation data.

### CROSS-REFERENCE TO RELATED APPLICATIONS

This application claims the benefit under 35 USC § 119(a) of Korean Patent Application No. 10-2023-0017831, filed on Feb. 10, 2023 in the Korean Intellectual Property Office, the entire disclosure of which is incorporated herein by reference for all purposes.

### BACKGROUND

### 1. Field

The following description relates to an apparatus and method with a neural network operation of homomorphic encrypted data.

### 2. Description of Related Art

Homomorphic encryption is an encryption method that allows a random operation between encrypted data. When using homomorphic encryption, not only may a random operation of encrypted data in an encrypted state be performed without decrypting the encrypted data, but the homomorphic encryption may also be safe because the homomorphic encryption is resistant to a quantum algorithm since the homomorphic encryption is lattice-based.

To perform a neural network operation for fully homomorphic encrypted data, a low-degree polynomial may be used as an activation function. However, to accurately approximate a rectified linear unit (ReLU) among neural network operations with a polynomial, a high-degree polynomial may be required.

When a low-degree polynomial is used for performing a neural network operation using fully homomorphic encrypted data, a layer of the neural network may not be stacked deep, and it may be difficult to achieve high performance.

In a neural network operation for fully homomorphic encrypted data, it may not be possible to use a general-purpose activation function such as a ReLU function. Thus, a user may have to newly train a model because it may not be possible to use a pre-trained neural network without a change.

In addition, since a high-degree polynomial is required to accurately approximate a ReLU with a polynomial, a lot of bootstrapping and excessive time may be required to implement a fully homomorphic encryption operation in a deep neural network.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an apparatus with a neural network operation of homomorphic encrypted data includes: one or more processors configured to: generate homomorphic conjugation data of encrypted data based on the encrypted data, wherein the encrypted data corresponds to an output of each of a plurality of layers included in a neural network; and remove noise of the encrypted data based on the encrypted data and the homomorphic conjugation data.

The apparatus may include a receiver configured to receive the encrypted data, wherein, for the generating of the homomorphic conjugation data, the one or more processors are configured to generate the homomorphic conjugation data based on the received encrypted data.

For the removing of the noise, the one or more processors may be configured to remove an imaginary part of the encrypted data.

For the generating of the homomorphic conjugation data, the one or more processors may be configured to perform a homomorphic conjugation operation on the encrypted data.

For the removing of the noise, the one or more processors may be configured to: perform an addition operation of the encrypted data and the homomorphic conjugation data; and multiply a result of the addition operation by a predetermined value.

The encrypted data may include data having a ciphertext level less than or equal to a predetermined threshold value, and the one or more processors may be configured to: perform a bootstrapping operation on the encrypted data; and for the removing of the noise, remove noise of data on which the bootstrapping operation is completed.

The one or more processors may be configured to: adjust a last layer value of a fast Fourier transform (FFT) coefficient to a predetermined value; and for the performing of the bootstrapping operation, perform the bootstrapping operation based on the adjusted last layer value of the FFT coefficient.

The one or more processors may be configured to: generate a composite polynomial of approximate polynomials; and perform the neural network operation on the data on which the bootstrapping operation is completed, based on the composite polynomial.

The composite polynomial may include a composite polynomial of minimax approximate polynomials.

The neural network operation may include a rectified linear unit (ReLU) function operation.

In one or more general aspects, a processor-implemented method with a neural network operation of homomorphic encrypted data includes: generating homomorphic conjugation data of encrypted data based on the encrypted data, wherein the encrypted data corresponds to an output of each of a plurality of layers included in a neural network; and removing noise of the encrypted data based on the encrypted data and the homomorphic conjugation data.

The generating of the homomorphic conjugation data may include performing a homomorphic conjugation operation on the encrypted data.

The removing of the noise may include removing an imaginary part of the encrypted data.

The removing of the noise may include: performing an addition operation of the encrypted data and the homomorphic conjugation data; and multiplying a result of the addition operation by a predetermined value.

The method may include performing a bootstrapping operation on the encrypted data, wherein the encrypted data may include data having a ciphertext level less than or equal to a predetermined threshold value, wherein the obtaining of the homomorphic conjugation data may include obtaining homomorphic conjugation data of data on which the bootstrapping operation is completed, and wherein the removing of the noise may include removing noise of the data on which the bootstrapping operation is completed, based on the data on which the bootstrapping operation is completed and the homomorphic conjugation data of the data on which the bootstrapping operation is completed.

The method may include adjusting a last layer value of a fast Fourier transform (FFT) coefficient to a predetermined value, wherein the performing of the bootstrapping operation may include performing the bootstrapping operation based on the adjusted last layer value of the FFT coefficient.

The method may include: generating a composite polynomial of approximate polynomials; and performing the neural network operation on the data on which the bootstrapping operation is completed, based on the composite polynomial.

The composite polynomial may include a composite polynomial of minimax approximate polynomials.

The performing of the neural network operation further may include performing a rectified linear unit (ReLU) function operation.

In one or more general aspects, a non-transitory computer-readable storage medium stores instructions that, when executed by a processor, configure the processor to perform any one, any combination, or all of operations and/or methods described herein.

Other features and aspects will be apparent from the following detailed description, the drawings, and the claims.

### BRIEF DESCRIPTION OF THE DRAWINGS

FIG. 1 illustrates an example of a neural network operation apparatus.

FIG. 2A illustrates an example of a neural network operation performed in an encrypted state using homomorphic encryption.

FIG. 2B illustrates an example of complex noise input to a composite polynomial of approximate polynomials and a resulting value diverging.

FIG. 3 illustrates an example of an operation method of performing a neural network operation on homomorphic encrypted data.

FIG. 4 illustrates an example of performing a bootstrapping operation and a rectified linear unit (ReLU) function operation.

FIG. 5 illustrates an example of a method of removing noise through a pre-operation.

FIG. 6 illustrates an example of a method of removing noise through a pre-calculation of a bootstrapping parameter.

FIG. 7 illustrates an example of an effect of removing noise.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms used herein including technical or scientific terms have the same meanings as those generally understood by one of ordinary skill in the art to which this disclosure pertains and based on an understanding of the disclosure of the present disclosure.

Terms, such as those defined in commonly used dictionaries, should be construed to have meanings matching with contextual meanings in the relevant art and the present disclosure, and are not to be construed as an ideal or excessively formal meaning unless otherwise defined herein.

In addition, when describing the examples with reference to the accompanying drawings, like reference numerals refer to like components and a repeated description related thereto will be omitted. When describing the examples, if it is determined that a detailed description of a related known art may unnecessarily obscure the gist of the examples, the detailed description will be omitted.

Although terms, such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “connected to,” “coupled to,” or “joined to” another component or element, it may be directly (e.g., in contact with the other component or element) “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning. The use of the term “may” herein with respect to an example or embodiment, e.g., as to what an example or embodiment may include or implement, means that at least one example or embodiment exists where such a feature is included or implemented, while all examples are not limited thereto.

A component that has common functions with another component included in one example will be described using the same name in other examples. Unless otherwise indicated, descriptions in an example may be applied to another example and a repeated detailed description related thereto will be omitted.

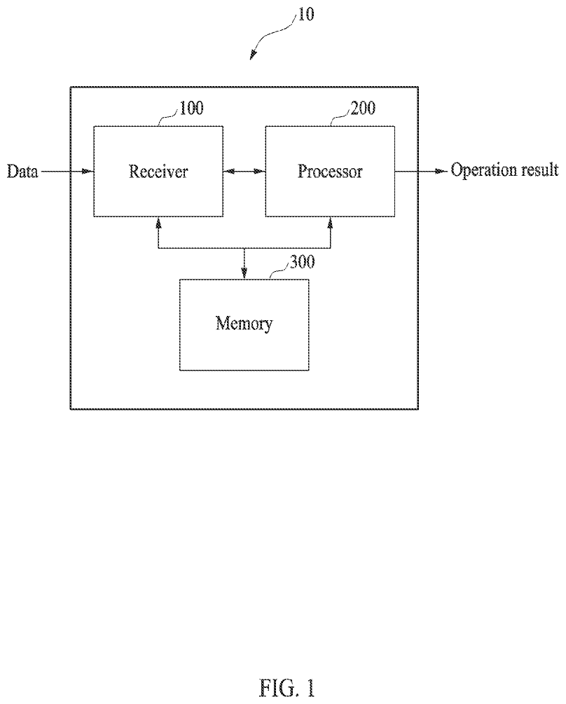

FIG. 1 illustrates an example of a neural network operation apparatus.

Referring to FIG. 1, a neural network operation apparatus 10 may perform a neural network operation. The neural network operation may include an operation for performing training or inference using a neural network.

The neural network operation apparatus 10 may perform a neural network operation of homomorphic encrypted data. Homomorphic encryption may be a method of encryption that is configured to perform various operations while data is encrypted. In the homomorphic encryption, a result of an operation using ciphertexts may be a new ciphertext, and a plaintext obtained by decrypting the ciphertexts may be the same as a result of an operation of original data before encryption.

A neural network may refer to an overall model in which nodes that form a network by synaptic coupling has a problem-solving ability by changing the strength of synaptic coupling through learning.

A node of the neural network may include a combination of weights or biases. The neural network may include at least one layer including at least one r node. The neural network may infer a result to be predicted from a random input by changing the weight of a node through learning.

The neural network may include a deep neural network (DNN). The neural network may include a convolutional neural network (CNN), a recurrent neural network (RNN), a perceptron, a multilayer perceptron, a feed forward (FF) neural network, a radial basis function (RBF) network, a deep feedforward (DFF) network, long short-term memory (LSTM), a gated recurrent unit (GRU), an autoencoder (AE), a variational autoencoder (VAE), a denoising autoencoder (DAE), a sparse autoencoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), a binarized neural network (BNN), and an attention network (AN).

The neural network operation apparatus 10 may be implemented in a personal computer (PC), a data server, or a portable device. The portable device may be implemented as a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal, or portable, navigation device (PND), a handheld game console, an e-book, or a smart device. The smart device may be implemented as a smart watch, a smart band, or a smart ring.

The neural network operation apparatus 10 may perform a neural network operation using an accelerator. The neural network operation apparatus 10 may perform the neural network operation using an accelerator. The neural network operation apparatus 10 may be implemented inside or outside of the accelerator.

The accelerator may include a neural processing unit (NPU), a graphics processing unit (GPU), a field programmable gate array (FPGA), an application-specific integrated circuit (ASIC), or an application processor (AP). The accelerator may also be implemented as a computing environment, such as a virtual machine.

The neural network operation apparatus 10 may include a receiver 100 and a processor 200 (e.g., one or more processors). The neural network operation apparatus 10 may further include a memory 300 (e.g., one or more memories).

The receiver 100 may include a receiving interface. The receiver 100 may receive data. The receiver 100 may receive data from outside or from the memory 300. The receiver 100 may output the received data to the processor 200. The receiver 100 may receive encrypted data for performing a neural network operation. The encrypted data may include encrypted input data.

The processor 200 may process data stored in the memory 300. The processor 200 may execute computer-readable code (e.g., software) stored in the memory 300 and instructions induced by the processor 200. For example, the memory 300 may be or include a non-transitory computer-readable storage medium storing instructions that, when executed by the processor 200, configure the processor 200 to perform any one, any combination, or all of operations and methods described herein with reference to FIGS. 1-7.

The processor 200 may be a hardware-implemented data processing device with a circuit that has a physical structure to perform desired operations. For example, the desired operations may include code or instructions in a program.

For example, the hardware-implemented data processing device may include a microprocessor, a central processing unit (CPU), a processor core, a multi-core processor, a multiprocessor, an ASIC, and an FPGA.

The processor 200 may obtain homomorphic conjugation data of encrypted data based on the encrypted data and remove noise of the encrypted data based on the encrypted data and the homomorphic conjugation data.

The processor 200 may remove an imaginary part of encrypted data. The processor 200 may perform a homomorphic conjugation operation on encrypted data. The processor 200 may perform a sum operation of encrypted data and homomorphic conjugation data and multiply a result of the sum operation by a predetermined value. The predetermined value may be, for example, “0.5”.

Encrypted data may include data having a ciphertext level less than or equal to a predetermined value. The processor 200 may perform a bootstrapping operation on data from which noise is removed. The processor 200 may adjust a last layer value of a fast Fourier transform (FFT) coefficient to a predetermined value and perform the bootstrapping operation based on the adjusted last layer value of the FFT coefficient.

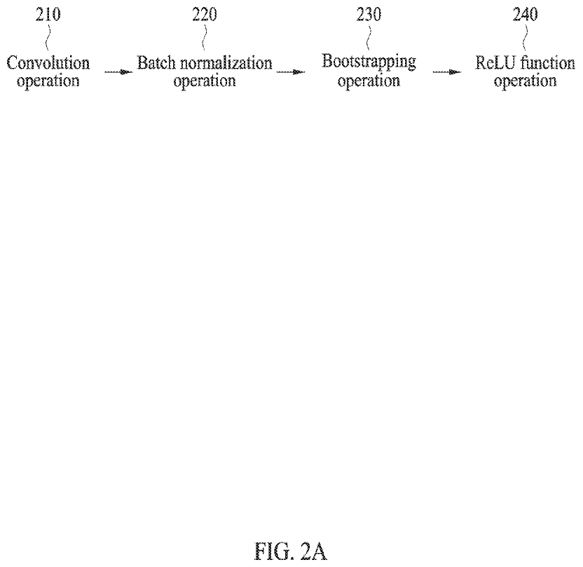

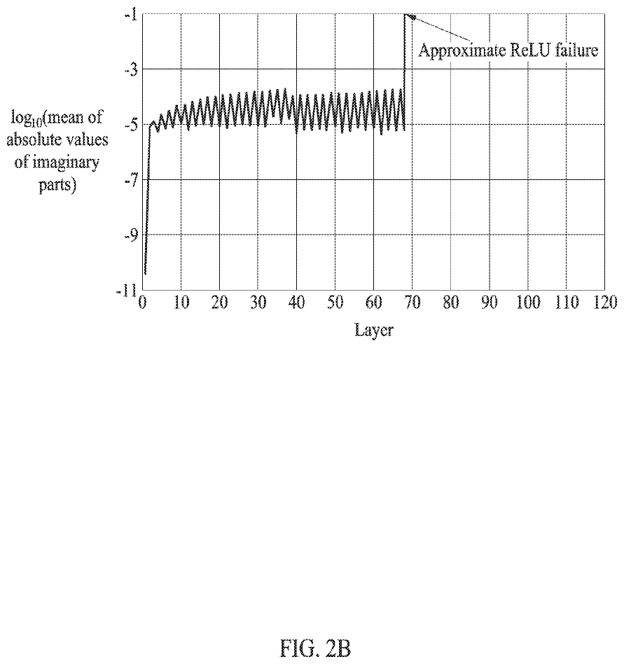

The processor 200 may generate an approximate polynomial and perform a neural network operation on data on which the bootstrapping operation is completed, based on a composite polynomial of approximate polynomials. The approximate polynomial may include a minimax approximate polynomial and the neural network operation may include a rectified linear unit (ReLU) function operation. Examples of operations of the processor 200 are described in detail with reference to FIGS. 2A to 6 below.

The memory 300 may store instructions (or programs) that are executable by the processor 200. For example, the instructions may include instructions to execute an operation of the processor 200 and/or an operation of each component of the processor 200.

The memory 300 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), holographic memory, a molecular electronic memory device, or insulator resistance change memory.

Deep learning may be a method for data analysis and data processing services using deep learning models may be provided for people using cloud computing. Deep learning may also be used for analyzing data that requires security maintenance such as financial information, CCTV data, and patient medical information. When a customer with data requests data analysis from another server that has a deep learning model, the customer may not easily send the data to the server when the security of the customer's data must be maintained. To this end, the customer may need to encrypt the data and send the encrypted data to the server. However, it may be difficult for the server that receives the encrypted data to perform desired operations between the data without decryption.

An encryption scheme configured to solve this problem may be homomorphic encryption.

As described above, homomorphic encryption may be an encryption scheme that supports an operation, addition, and multiplication between encrypted data, where this operation may be performed without performing a special decryption process. Thus, when the customer's data is encrypted using homomorphic encryption, the server may be able to perform the desired operations without exposing information of the customer's data, such that the data may be processed while maintaining security. For example, when a neural network operation is performed in a state in which the data is encrypted using homomorphic encryption, the data privacy problem in an artificial intelligence (AI) service of a cloud system may be solved.

FIG. 2A illustrates an example of a neural network operation performed in an encrypted state using homomorphic encryption and FIG. 2B illustrates an example of complex noise input to a composite polynomial of approximate polynomials and a resulting value diverging.

A neural network may receive homomorphic encrypted input data (for example, a homomorphic encrypted image). The neural network may include a plurality of layers, and a layer may define a mapping of outputs to inputs. In a CNN, for example, a mapping defined by a layer may be executed as at least one convolution kernel to be applied to input data such as an image or a specific feature map to generate next feature maps as an output of the layer.

During a forward processing, a layer may receive homomorphic encrypted input data and generate a homomorphic encrypted first feature map as an output. During the forward processing, the next layer may receive the homomorphic encrypted first feature map that is generated by the previous layer as an input and generate a homomorphic encrypted second feature map as an output. During the forward processing, the next layer may receive the homomorphic encrypted second feature map as an input and generate the next feature map as an output. One or more or all layers that receive and generate a feature map may be hidden layers (for example, hidden convolutional layers). In addition to applying convolutional kernels that map input feature maps to output feature maps (e.g., convolution operation 210 of FIG. 2A), other neural network operations may be performed. Referring to FIG. 2A, examples of such other neural network operations may include a batch normalization operation 220, a bootstrapping operation 230, and a ReLU function operation 240 but are not limited thereto. As described below, encrypted data for performing a neural network operation may include encrypted data corresponding to an output of each of a plurality of layers included in a neural network. A ReLU function may be a kind of non-linear activation function. A non-linear activation function is one of the technologies that have contributed to the development of deep learning the most. Examples of a non-linear activation function may include a ReLU function, a sigmoid function, a leaky-ReLU function, or a sign function. Such non-linear functions may easily perform an operation on a plaintext but may not be able to perform an exact operation on a ciphertext that only supports addition and multiplication. When operations (e.g., a CNN operation, etc.) used in deep learning are mostly linear functions, such operations may be implemented using homomorphic encryption. Thus, deciding which method to use in an operation of a non-linear activation function may be an important matter.

To this end, a ReLU function may be applied to an existing deep learning model by approximating as exactly as possible. For example, a ReLU function may be performed in an encrypted state by generating a good approximate polynomial using polynomial approximation and performing the approximate polynomial in an encrypted state.

Approximate homomorphic encryption may be configured to support not only real numbers but also complex numbers. In addition, due to a characteristic of encryption, noise may be inserted in a message not only in a real part but also in an imaginary part. Thus, in a process of performing a ReLU function operation, an input of a composite approximate polynomial may be input with small complex number noise added to a real number. When complex noise is inserted into the input of the composite approximate polynomial, there may be a value outside of a planned range in a process of sequentially calculating polynomials. Subsequently, when the polynomials are calculated, a resulting value may completely diverge. Referring to FIG. 2B, it may be found that, when complex noise is input to a composite polynomial of approximate polynomials, a resulting value diverges.

For example, when complex noise is input to a composite polynomial of approximate polynomials, performing of a ReLU function operation may fail, which may lead to failure of the whole deep-learning system. A divergence phenomenon like this may become more probable the deeper the deep-learning network that is performed. For example, when “110” layers are performed, the above divergence phenomenon may occur with a probability of about 25%.

As described in detail below, a method of one or more embodiments of performing a neural network operation may remove complex noise of encrypted data using homomorphic conjugation data of the encrypted data and, consequently, the method of one or more embodiments may prevent failure of a neural network operation including a ReLU function operation.

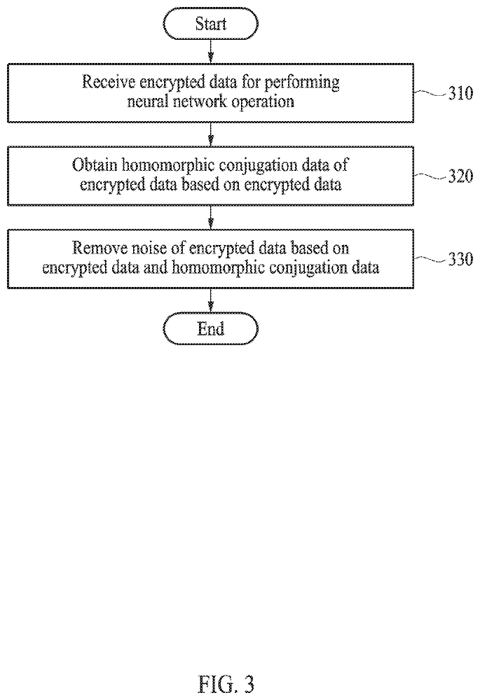

FIG. 3 illustrates an example of an operation method of performing a neural network operation on homomorphic encrypted data.

For convenience of description, operations 310 to 330 are described as they are performed using the neural network operation apparatus 10 illustrated in FIG. 1. However, operations 310 to 330 may be used using any other suitable electronic device and in any other suitable system.

Furthermore, the operations illustrated in FIG. 3 may be performed in the order and way illustrated in FIG. 3, but the order of some operations may be changed, or some operations may be omitted without departing from the spirit and scope of the illustrated example. Multiple operations illustrated in FIG. 3 may be performed in parallel or simultaneously.

Referring to FIG. 3, in operation 310, the neural network operation apparatus 10 may receive encrypted data for performing a neural network operation. The neural network operation apparatus 10 may receive encrypted data corresponding to an output of each of a plurality of layers included in a neural network. For example, in operation 310, the neural network operation apparatus 10 may receive, as the encrypted data, a ciphertext c₁, of an output vector x=\vec{v}+i\vec{e} included in a feature map of each of the plurality of layers included in the neural network. A relationship between the ciphertext and the vector may be illustrated as in Equation 1 below, for example.

$$c {t}_{1} = Enc ( \vec{v} + i \vec{e} ) \qquad Equation 1$$

In Equation 1, Enc( ) may represent a homomorphic encryption operation and vectors \vec{v}, and \vec{e} may represent a real number vector. Data may be loaded on the real part \vec{v} and the imaginary part i\vec{e} may be noise.

In operation 320, the neural network operation apparatus 10 may obtain homomorphic conjugation data of the encrypted data based on the encrypted data. For example, in operation 320, the neural network operation apparatus 10 may perform a homomorphic conjugation operation on the encrypted data according to Equation 2 below, for example.

$$Conj ( {ct}_{1} ) = Enc ( \overline{x} ) = Enc ( \vec{v} - i \vec{e} ) \qquad Equation 2$$

In operation 330, the neural network operation apparatus 10 may remove noise of the encrypted data based on encrypted data x and homomorphic conjugation data x̅. The neural network operation apparatus 10 may remove noise of an imaginary part of the encrypted data by adding the encrypted data x and the homomorphic conjugation data x̅ and multiply the resulting value of adding the encrypted data x and the homomorphic conjugation data x̅ by “0.5” according to Equation 3 below, for example.

$$( c {t}_{1} + Conj ( {ct}_{1} ) ) * 0.5 = ( Enc ( \vec{v} + i \vec{e} ) + Enc ( \vec{v} - i \vec{e} ) ) * 0.5 = Enc ( 2 \vec{v} * 0.5 ) = Enc ( \vec{v} ) \qquad Equation 3$$

Removing noise of an imaginary part may be performed in combination with a bootstrapping operation, and subsequently, a non-linear function operation may be performed. However, removing noise of an imaginary part does not necessarily need to be performed right before a non-linear function operation. For example, removing noise of an imaginary part may be performed periodically right after a non-linear function operation. Alternatively, removing noise of an imaginary part may be performed periodically at a predetermined time during an interval between non-linear function operations.

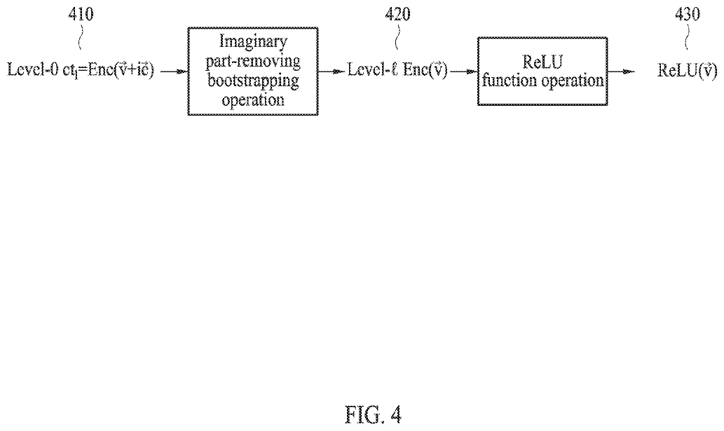

FIG. 4 illustrates an example of performing a bootstrapping operation and a ReLU function operation. Descriptions given with reference to FIGS. 1 to 3 may apply to FIG. 4 and a repeated description may be omitted.

The neural network operation apparatus 10 may perform a bootstrapping operation in conjunction with removing noise of an imaginary part. Due to a characteristic of a homomorphic encryption system that a noise value is added to a lower bit of a ciphertext, when repeated operations are performed on ciphertexts, a noise value that has increased in size may intrude a message value. Thus, to prevent the noise value from intruding the message value, the number of operations may be limited such that operations are performed only until a noise value induced by repeated operations of ciphertexts does not intrude a message value. An operation that tracks the size of noise and reduces the size of noise of a ciphertext that has reached a limit may be a bootstrapping operation. The number of operations may be referred to as a level.

The neural network operation apparatus 10 may receive data having a level less than or equal to a predetermined threshold value. For example, the neural network operation apparatus 10 may receive ct₁=Enc(\vec{v}+i\vec{e}) 410 having a level “0.” The neural network operation apparatus 10 may perform a bootstrapping operation on the data having the level “0” and perform an operation of removing noise on data on which the bootstrapping operation is completed, which is described above with reference to FIG. 3 to generate output Level- [symbol] Enc(\vec{v}) 420.

The neural network operation apparatus 10 may generate a composite polynomial of approximate polynomials, perform a neural network operation on data on which a bootstrapping operation is completed, based on the composite polynomial, and output a result ReLU(v) 430. A method of approximation may include a minimax composite approximation method. A minimax composite approximation method may be a method of approximating a sign function by composition of a minimax approximate polynomial with a low degree. However, a method of approximation is not limited to a minimax composite approximation method and may employ various approximation methods. The neural network operation apparatus 10 may perform a non-linear function operation using data from which complex noise is removed and may thus prevent a value from diverging.

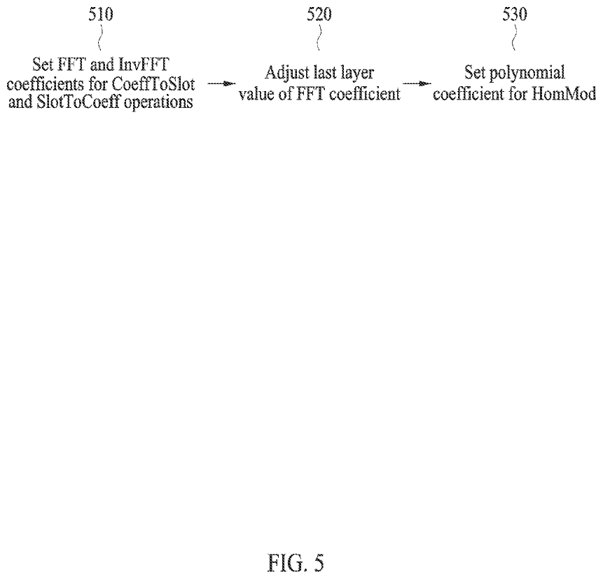

FIG. 5 illustrates an example of a method of removing noise through a pre-operation.

When a ciphertext of a complex number x is given,

$$\frac{x + \overline{x}}{2}$$

may be calculated homomorphically to remove an imaginary part through a ciphertext operation. Here, dividing by “2” may be performed through multiplying by “0.5,” but this may unnecessarily consume one additional level.

Referring to FIG. 5, the method of one or more embodiments of removing noise through the pre-operation may perform a multiplication by “0.5” without additionally consuming a level by modifying a pre-calculation process of a bootstrapping parameter.

For example, the neural network operation apparatus 10 may repeatedly perform a bootstrapping operation. For example, the neural network operation apparatus 10 may perform a bootstrapping operation every time a level reaches a predetermined value. Alternatively, the neural network operation apparatus 10 may perform a bootstrapping operation according to a predetermined period. In each bootstrapping operation, the neural network operation apparatus 10 may pre-calculate a bootstrapping parameter before performing a corresponding bootstrapping operation, and here, may modify the parameter and thus may perform a multiplication by “0.5” without additionally consuming a level.

In operation 510, an FFT coefficient and an inverse FFT (IFFT) coefficient for a CoeffToSlot operation and a SlotToCoeff operation may be set in a pre-calculation process of a bootstrapping parameter. Here, in operation 520, the neural network operation apparatus 10 may adjust all the last layer values of the FFT coefficient for the SlotToCoeff operation of a corresponding bootstrapping operation to a half. Subsequently, in operation 530, the neural network operation apparatus 10 may set a polynomial coefficient for HomMod.

The neural network operation apparatus 10 of one or more embodiments may perform a bootstrapping operation after performing a pre-calculation process of a modified parameter and consequently may perform a multiplication by “0.5” without consuming an additional level. For example, the neural network operation apparatus 10 may receive a ciphertext of x having a level “0” and generate a ciphertext of x/2 having a level “ [symbol] ” without consuming an additional level.

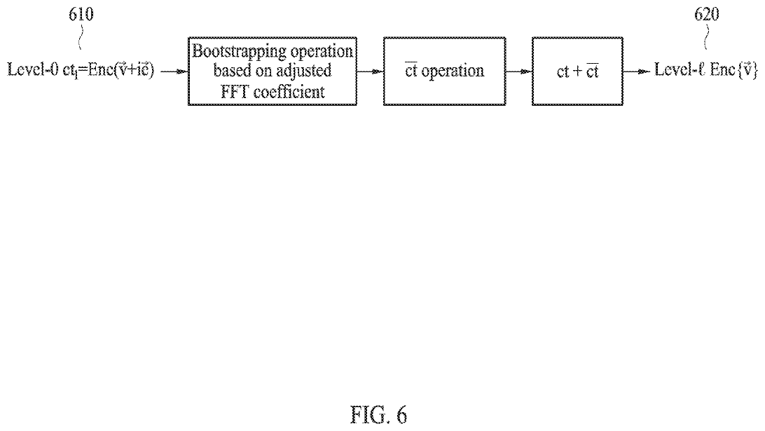

FIG. 6 illustrates an example of a method of removing noise through a pre-calculation of a bootstrapping parameter. Referring to FIG. 6, an imaginary part-removing bootstrapping operation may mean homomorphically performing

$$\frac{x + \overline{x}}{2} = Re \{ x \}$$

on a given complex number x.

The neural network operation apparatus 10 of one or more embodiments may perform a multiplication by “0.5” without consuming an additional level by using a pre-calculation process of a modified bootstrapping parameter. The neural network operation apparatus 10 may perform an operation ct₁+c̅t̅₁̅ using a homomorphic conjugation operation. For example, in a ciphertext ct₁ 610 of x, the neural network operation apparatus 10 may calculate ct₁+c̅t̅₁̅ after obtaining c̅t̅₁̅ using a homomorphic conjugation operation, and consequently, may immediately obtain a ciphertext of x+\tilde{x}. As a result, the neural network operation apparatus 10 may output Level- [symbol] Enc{\vec{v}} 620 without consuming an additional level by performing an imaginary part-removing bootstrapping operation.

Additionally, or alternatively, the neural network operation apparatus 10 may homomorphically calculate c(x+x̅) for any constant “c” other than “0” instead of

$$\frac{x + \overline{x}}{2} .$$

Here, the neural network operation apparatus 10 may remove noise in an imaginary part by homomorphically performing a multiplication by “2/c” consuming an additional level. Alternatively, the neural network operation apparatus 10 may merge the multiplication by “2/c” with another element on a deep-learning network, such as convolution and the like.

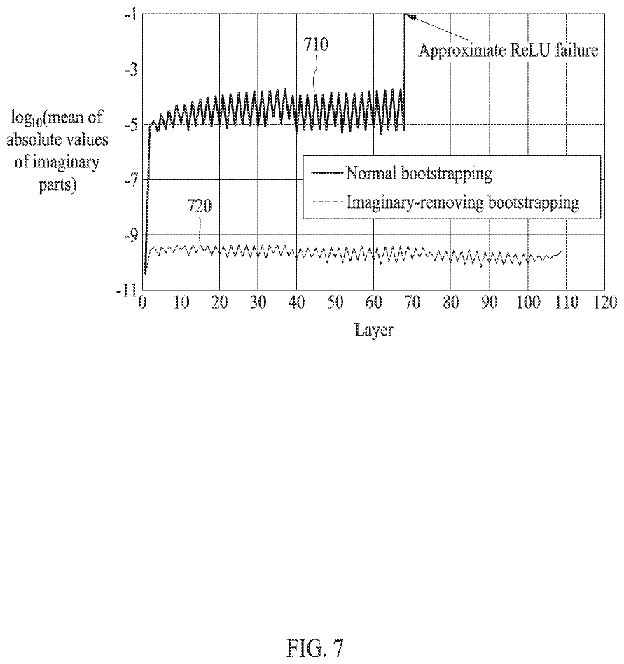

FIG. 7 illustrates an example of an effect of removing noise.

Referring to FIG. 7, a graph 710 illustrates a mean of absolute values of an imaginary part after each layer when ResNet-110 inference is performed through a normal bootstrapping operation and a graph 720 illustrates a mean of absolute values of an imaginary part after each layer when ResNet-110 inference is performed after removing noise according to one or more embodiments.

Referring to the graph 710, it may be found that a resulting value diverges when complex noise is input to a composite polynomial of approximate polynomials. On the other hand, referring to the graph 720, it may be found that a resulting value does not diverge after an inference is performed, since noise of an imaginary part is removed.

The neural network operation apparatuses, receivers, processors, memories, neural network operation apparatus 10, receiver 100, processor 200, memory 300, and other apparatuses, devices, units, modules, and components disclosed and described herein with respect to FIGS. 1-7 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An apparatus with a neural network operation of homomorphic encrypted data, the apparatus comprising:
one or more processors configured to:
generate homomorphic conjugation data of encrypted data based on the encrypted data, wherein the encrypted data corresponds to an output of each of a plurality of layers included in a neural network; and
remove noise of the encrypted data based on the encrypted data and the homomorphic conjugation data.

2. The apparatus of claim 1, further comprising a receiver configured to receive the encrypted data,
wherein, for the generating of the homomorphic conjugation data, the one or more processors are configured to generate the homomorphic conjugation data based on the received encrypted data.

3. The apparatus of claim 1, wherein, for the removing of the noise, the one or more processors are configured to remove an imaginary part of the encrypted data.

4. The apparatus of claim 1, wherein, for the generating of the homomorphic conjugation data, the one or more processors are configured to perform a homomorphic conjugation operation on the encrypted data.

5. The apparatus of claim 1, wherein, for the removing of the noise, the one or more processors are configured to:
perform an addition operation of the encrypted data and the homomorphic conjugation data; and
multiply a result of the addition operation by a predetermined value.

6. The apparatus of claim 1, wherein
the encrypted data comprises data having a ciphertext level less than or equal to a predetermined threshold value, and
the one or more processors are configured to:
perform a bootstrapping operation on the encrypted data; and
for the removing of the noise, remove noise of data on which the bootstrapping operation is completed.

7. The apparatus of claim 6, wherein the one or more processors are configured to:
adjust a last layer value of a fast Fourier transform (FFT) coefficient to a predetermined value; and
for the performing of the bootstrapping operation, perform the bootstrapping operation based on the adjusted last layer value of the FFT coefficient.

8. The apparatus of claim 7, wherein the one or more processors are configured to:
generate a composite polynomial of approximate polynomials; and
perform the neural network operation on the data on which the bootstrapping operation is completed, based on the composite polynomial.

9. The apparatus of claim 8, wherein the composite polynomial comprises a composite polynomial of minimax approximate polynomials.

10. The apparatus of claim 8, wherein the neural network operation comprises a rectified linear unit (ReLU) function operation.

11. A processor-implemented method with a neural network operation of homomorphic encrypted data, the method comprising:
generating homomorphic conjugation data of encrypted data based on the encrypted data, wherein the encrypted data corresponds to an output of each of a plurality of layers included in a neural network; and
removing noise of the encrypted data based on the encrypted data and the homomorphic conjugation data.

12. The method of claim 11, wherein the generating of the homomorphic conjugation data comprises performing a homomorphic conjugation operation on the encrypted data.

13. The method of claim 11, wherein the removing of the noise comprises removing an imaginary part of the encrypted data.

14. The method of claim 11, wherein the removing of the noise comprises:
performing an addition operation of the encrypted data and the homomorphic conjugation data; and
multiplying a result of the addition operation by a predetermined value.

15. The method of claim 11, further comprising performing a bootstrapping operation on the encrypted data,
wherein the encrypted data comprises data having a ciphertext level less than or equal to a predetermined threshold value,
wherein the obtaining of the homomorphic conjugation data comprises obtaining homomorphic conjugation data of data on which the bootstrapping operation is completed, and
wherein the removing of the noise comprises removing noise of the data on which the bootstrapping operation is completed, based on the data on which the bootstrapping operation is completed and the homomorphic conjugation data of the data on which the bootstrapping operation is completed.

16. The method of claim 15, further comprising adjusting a last layer value of a fast Fourier transform (FFT) coefficient to a predetermined value,
wherein the performing of the bootstrapping operation comprises performing the bootstrapping operation based on the adjusted last layer value of the FFT coefficient.

17. The method of claim 16, further comprising:
generating a composite polynomial of approximate polynomials; and
performing the neural network operation on the data on which the bootstrapping operation is completed, based on the composite polynomial.

18. The method of claim 17, wherein the composite polynomial comprises a composite polynomial of minimax approximate polynomials.

19. The method of claim 17, wherein the performing of the neural network operation further comprises performing a rectified linear unit (ReLU) function operation.

20. A non-transitory computer-readable storage medium storing instructions that, when executed by one or more processors, configure the one or more processors to perform the method of claim 11.
